(19) United States
(12) Patent Application Publication
(10) Pub. No.: US 2009/0124771 A1
(43) Pub. Date: May 14, 2009

(54) POLYMERIZATION CATALYST AND METHOD FOR PRODUCING POLY-ALPHA-OLEFIN USING THE CATALYST

(75) Inventor: Masami KANAMARU, Ichihara-shi Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd, chiyoda-ku tokyo (JP)

(21) Appl. No.: 11/911,727

(22) PCT Filed: Apr. 11, 2006
(86) PCT No.: PCT/JP2006/307657

§ 371 Date: Oct. 17, 2007

(30) Foreign Application Priority Data
Apr. 28, 2005 (JP) 2005-132927

(51) Int. Cl. C08F 4/52

(52) U.S. Cl. 526/133; 502/117

(57) ABSTRACT

The present invention provides a polymerization catalyst prepared by bringing (A) a transition metal compound, (B) a solid boron compound capable of forming an ion pair with the component (A), (C) an organoaluminum compound, and (D) one or two or more kinds of compounds selected from an α-olefin, an internal olefin and a polyene into contact with each other, the polymerization catalyst being a polymerization catalyst having high activity or a homogeneous polymerization catalyst having high activity and capable of being easily fed into a polymerization reaction system; and a method for producing a poly-α-olefin by polymerizing an α-olefin having from 3 to 30 carbon atoms by using such a catalyst.

### TECHNICAL FIELD

The present invention relates to a polymerization catalyst obtained by bringing (A) a transition metal compound, (B) a solid boron compound capable of forming an ion pair with the component (A), (C) an organoaluminum compound and (D) one or two or more kinds of compounds selected from an α-olefin, an internal olefin and a polyene into contact with each other and to a method for producing a poly-α-olefin using the catalyst.

### BACKGROUND ART

In the polymerization of an α-olefin using a metallocene catalyst, methylaluminoxane and boron compounds are generally used as a co-catalyst.

In the case of using a boron compound as the co-catalyst, since certain kinds of boron compounds are sparingly soluble in a hydrocarbon based solvent, in order to feed continuously a homogenous catalyst into a polymerization reaction tank of an α-olefin, it is carried out to prepare a homogenous catalyst by bringing a transition metal compound and a boron compound into contact with each other in a hydrocarbon solvent in the presence or absence of an organoaluminum compound prior to the polymerization (see, for example, Patent Documents 1 to 2).

By employing this technology, though it has become easy to feed the catalyst into a polymerization reaction system, it is demanded that the polymerization activity is more enhanced.

Also, it is also proposed that, without preparing a homogeneous catalyst in advance, a boron compound which is sparingly soluble in a solvent is made to have a small particle size and are dispersed in a hydrocarbon solvent to form a slurry, which is then fed continuously into a polymerization reaction tank of an α-olefin (see, for example, Patent Document 3).

The method of using this boron compound slurry involves problems that a transfer rate of the slurry and a length of a conduit to the polymerization reaction tank of an α-olefin are restricted; and that the polymerization activity of the α-olefin is not sufficient.

Furthermore, in catalysts other than a homogeneous system which is produced by using a transition metal compound and an organoboron compound, it is also demanded that the activity is more enhanced.

Patent Document 1: Japanese Patent No. 2918193

Patent Document 2: Japanese Patent No. 2939321

Patent Document 3: Japanese Patent No. 3456394

### DISCLOSURE OF THE INVENTION

In view of the foregoing viewpoints, the present invention has been made, and its object is to provide a polymerization catalyst having high activity or a homogeneous polymerization catalyst having high activity and capable of being easily fed into a polymerization reaction system and a method for producing a poly-α-olefin using such a catalyst.

The present inventors have found that a catalyst obtained by bringing (A) a transition metal compound, (B) a solid boron compound capable of forming an ion pair with the component (A), (C) an organoaluminum compound and (D) one or two or more kinds of compounds selected from an α-olefin, an internal olefin and a polyene into contact with each other has high activity and that when this catalyst is a homogenous catalyst, it is easily fed into a polymerization reaction system, leading to accomplishment of the present invention.

The present invention provides:

(1) A polymerization catalyst which is produced by bringing (A) a transition metal compound, (B) a solid boron compound capable of forming an ion pair with the component (A), (C) an organoaluminum compound, and (D) one or two or more kinds of compounds selected from an α-olefin, an internal olefin and a polyene into contact with each other;
(2) The polymerization catalyst as set forth above in (1), wherein the component (D) is an α-olefin having from 3 to 30 carbon atoms and the component (D)/component (A) are brought into contact in a molar ratio of from 10 to 100,000;
(3) The polymerization catalyst as set forth above in (1) or
(2), wherein the components (A), (B), (C) and (D) are brought into contact with each other in the presence of (E) a hydrocarbon based solvent;
(4) The polymerization catalyst as set forth above in any one of (1) to (3), wherein the component (E) is an aliphatic hydrocarbon based solvent;
(5) The polymerization catalyst as set forth above in any one of (1) to (3), wherein the component (E) is an alicyclic hydrocarbon based solvent;
(6) The polymerization catalyst as set forth above in any one of (1) to (5), wherein the polymerization catalyst is a homogenous catalyst;
(7) The polymerization catalyst as set forth above in any one of (1) to (6), wherein the component (A) is a crosslinked ligand-containing metallocene complex;
(8) The polymerization catalyst as set forth above in (7), wherein the crosslinked ligand-containing metallocene complex is a double-crosslinked metallocene complex represented by the general formula (I):

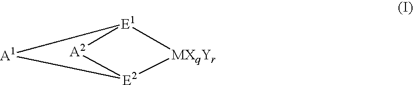

[in the formula, M represents a metal element belonging to the groups 3 to 10 of the periodic table or the lanthanoid series; E¹ and E² each represents a ligand selected from a substituted cyclopentadienyl group, an indenyl group, a substituted indenyl group, a heterocyclopentadienyl group, a substituted heterocyclopentadienyl group, an amide group, a phosphide group, a hydrocarbon group, and a silicon-containing group and forms a crosslinking structure via A¹ and A², and E¹ and E² may be the same or different; X represents a σ-bonding ligand, and when plural Xs are present, the plural Xs may be the same or different or may be crosslinked with other X, E¹, E² or Y; Y represents a Lewis base, and when plural Ys are present, the plural Ys may be the same or different or may be crosslinked with other Y, E¹, E² or X; A¹ and A² each represents a divalent crosslinking group for bonding two ligands and represents a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—; R¹ represents a hydrogen atom, a halogen atom, a hydrocarbon group having from 1 to 20 carbon atoms, or a halogen-containing hydrocarbon group having from 1 to 20 carbon atoms, and A¹ and A² may be the same or different; q represents an integer of from 1 to 5 and represents [(valence of M)−2]; and r represents an integer of from 0 to 3];
(9) The polymerization catalyst as set forth above in any one of (1) to (8), wherein the component (C) is selected from a compound represented by the general formula (VIII):

R²⁰ᵥAlJ₃₋ᵥ (VIII)

[in the formula, R²⁰ represents an alkyl group having from 1 to 10 carbon atoms; J represents a hydrogen atom, an alkoxy group having from 1 to 20 carbon atoms, an aryl group having from 6 to 20 carbon atoms, or a halogen atom; and v represents an integer of from 1 to 3],
a chain aluminoxane represented by the general formula (IX):

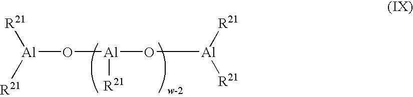

[in the formula, R²¹ represents from 1 to 20 carbon atoms; w represents an average degree of polymerization; and respective R²¹s may be the same or different], and
a cyclic aluminoxane represented by the general formula (X):

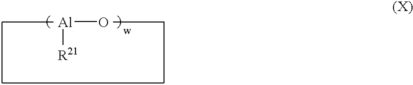

[in the formula, R²¹ and w are the same as those in the foregoing general formula (IX);
(9) A method for producing a poly-α-olefin, which is characterized by polymerizing an α-olefin having from 3 to 30 carbon atoms by using the polymerization catalyst as set forth above in any one of (1) to (9); and
(11) A method for producing a poly-α-olefin by continuously feeding the polymerization catalyst as set forth above in (10) into a polymerization reaction apparatus of an α-olefin having from 3 to 30 carbon atoms.

According to the present invention, a transition metal compound/organoboron compound based catalyst having high activity is obtained, and a poly-α-olefin is produced in a high yield with ease by polymerizing an α-olefin having from 3 to 30 carbon atoms by using the catalyst.

When the catalyst of the present invention is a homogeneous catalyst, it can be fed stably and continuously into a polymerization reaction system.

### BEST MODES FOR CARRYING OUT THE INVENTION

The polymerization catalyst of the present invention is obtained by bringing (A) a transition metal compound, (B) a solid boron compound capable of forming an ion pair with the component (A), (C) an organoaluminum compound and (D) one or two or more kinds of compounds selected from an α-olefin, an internal olefin and a polyene into contact with each other.

As the respective components in the polymerization catalyst of the present invention, the following compounds can be preferably used.

Examples of the transition metal compound (A) which is used in the present invention include a chelate type complex and a non-crosslinked ligand-containing or crosslinked ligand-containing metallocene complex.

Examples of the chelate type complex include N,N′-bis(2,6-diisopropylphenyl)-1,2-dimethylethylenediimino-nickeldibromide and N,N′-bis(2,6-diisopropylphenyl)-1,2-dimethylethylenediiminopalladium dibromide.

Examples of the non-crosslinked ligand-containing metallocene complex include biscyclopentadienylzirconium dichloride, bis(n-butylcyclopentadienyl) zirconium dichloride, bis(pentamethylcyclopentadienyl)zirconium dichloride, and bisindenylzirconium dichloride.

In the present invention, a metallocene complex in which a ligand forms a crosslinking structure via a crosslinking group is higher in polymerization activity than a metallocene complex in which a ligand does not form a crosslinking structure.

Accordingly, of the metallocene complexes, a metallocene complex in which a ligand forms a crosslinking structure via a crosslinking group is preferable; a single-crosslinked metallocene complex and a double-crosslinked metallocene complex are more preferable; and a double-crosslinked metallocene complex is the most preferable.

Examples of the single-crosslinked metallocene complex include dimethylsilylene(tetramethylcyclopentadienyl)-(3-tert-butyl-5-methyl-2-phenoxy)zirconium dichloride, dimethylsilylene(tetramethylcyclopentadienyl)(tert-butyl-amide)zirconium dichloride, dimethylsilylenebis(2-methyl-4,5-benzoindenyl)zirconium dichloride, dimethylsilylene-bis(2-methyl-4-phenylindenyl)zirconium dichloride, dimethylsilylenebis(2-methyl-4-naphthylindenyl)zirconium dichloride, dimethylsilylenebis(2-methylindenyl)zirconium dichloride, and ethylenebis(2-methylindenyl)zirconium dichloride.

Examples of the double-crosslinked metallocene complex include double-crosslinked metallocene complexes represented by the general formula (I).

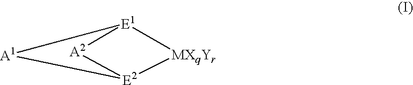

[In the formula, M represents a metal element belonging to the groups 3 to 10 of the periodic table or the lanthanoid series; E¹ and E² each represents a ligand selected from a substituted cyclopentadienyl group, an indenyl group, a substituted indenyl group, a heterocyclopentadienyl group, a substituted heterocyclopentadienyl group, an amide group, a phosphide group, a hydrocarbon group, and a silicon-containing group and forms a crosslinking structure via A¹ and A², and E¹ and E² may be the same or different; X represents a σ-bonding ligand, and when plural Xs are present, the plural Xs may be the same or different and may be crosslinked with other X, E¹, E² or Y; Y represents a Lewis base, and when plural Ys are present, the plural Ys may be the same or different or may be crosslinked with other Y, E¹, E² or X; A¹ and A² each represents a divalent crosslinking group for bonding two ligands and represents a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, PR¹—, —P(O)R¹—, —BR¹—, or —AlR¹—; R¹ represents a hydrogen atom, a halogen atom, a hydrocarbon group having from 1 to 20 carbon atoms, or a halogen-containing hydrocarbon group having from 1 to 20 carbon atoms, and A¹ and A² may be the same or different; q represents an integer of from 1 to 5 and represents [(valence of M)−2]; and r represents an integer of from 0 to 3.]

In the general formula (I), M represents a metal element belonging to the groups 3 to 10 of the periodic table or the lanthanoid series; and specific examples thereof include titanium, zirconium, hafnium, yttrium, vanadium, chromium, manganese, nickel, cobalt, palladium, and lanthanoid series metals. Of these, titanium, zirconium and hafnium are suitable from the standpoints of olefin polymerization activity and the like.

E¹ and E² each represents a ligand selected from a substituted cyclopentadienyl group, an indenyl group, a substituted indenyl group, a heterocyclopentadienyl group, a substituted heterocyclopentadienyl group, an amide group (—N<), a phosphine group (—P<), a hydrocarbon group [>CR— or >C<], and a silicon-containing group [>SiR— or >Si<] (wherein R represents hydrogen, a hydrocarbon group having from 1 to 20 carbon atoms, or a hetero atom-containing group and forms a crosslinking structure via A¹ and A².

Also, E¹ and E² may be the same or different.

As E¹ and E², a substituted cyclopentadienyl group, an indenyl group and a substituted indenyl group are preferable because the polymerization activity becomes higher.

Also, X represents a σ-bonding ligand, and when plural Xs are present, the plural Xs may be the same or different or may be crosslinked with other X, E¹, E² or Y.

Specific examples of X include a halogen atom, a hydrocarbon group having from 1 to 20 carbon atoms, an alkoxy group having from 1 to 20 carbon atoms, an aryloxy group having from 6 to 20 carbon atoms, an amide group having from 1 to 20 carbon atoms, a silicon-containing group having from 1 to 20 carbon atoms, a phosphide group having from 1 to 20 carbon atoms, a sulfide group having from 1 to 20 carbon atoms, and an acyl group having from 1 to 20 carbon atoms.

On the other hand, Y represents a Lewis base, and when plural Ys are present, the plural Ys may be the same or different or may be crosslinked with other Y, E¹, E² or X. Specific examples of the Lewis acid represented by Y include amines, ethers, phosphines, and thioethers.

Next, A¹ and A² each represents a divalent crosslinking group for bonding two ligands and represents a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—; R¹ represents a hydrogen atom, a halogen atom, a hydrocarbon group having from 1 to 20 carbon atoms, or a halogen-containing hydrocarbon group having from 1 to 20 carbon atoms; and A¹ and A² may be the same or different.

Examples of such a crosslinking group include groups represented by the following general formula.

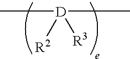

(D represents carbon, silicon or tin; R² and R³ each represents a hydrogen atom or a hydrocarbon group having from 1 to 20 carbon atoms, and R² and R³ may be the same or different or may be bonded to each other to form a ring structure; and e represents an integer of from 1 to 4.)

Specific examples thereof include a methylene group, an ethylene group, an ethylidene group, a propylidene group, an isopropylidene group, a cyclohexylidene group, a 1,2-cyclohexylene group, a vinylidene group (CH₂═C═), a dimethylsilylene group, a diphenylsilylene group, a methylphenylsilylene group, dimethylgermilene group, a dimethylstannylene group, a tetramethyldisilylene group, and a diphenyldisilylene group.

Of these, an ethylene group, an isopropylidene group and a dimethylsilylene group are suitable because the polymerization activity becomes higher.

q represents an integer of from 1 to 5 and represents [(valence of M)−2]; and r represents an integer of from 0 to 3.

Of these double-crosslinked metallocene complexes represented by the general formula (I), a metallocene complex containing, as a ligand, a double-crosslinked biscyclopentadienyl derivative and represented by the general formula (II) is preferable because the polymerization activity becomes higher.

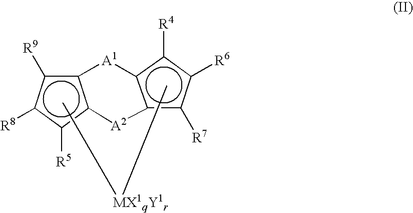

In the general formula (II), M, A¹, A², q and r are the same as those described above.

X¹ represents a σ-bonding ligand; and when plural X¹s are present, the plural X¹s may be the same or different or may be crosslinked with other X¹ or Y¹.

Specific examples of this X¹ include those exemplified as X of the general formula (I).

Y¹ represents a Lewis base, and when plural Y¹s are present, the plural Y¹s may be the same or different or may be crosslinked with other Y¹ or X¹.

Specific examples of this Y¹ include those exemplified as Y of the general formula (I).

R⁴ to R⁹ each represents a hydrogen atom, a halogen atom, a hydrocarbon group having from 1 to 20 carbon atoms, a halogen-containing hydrocarbon group having from 1 to 20 carbon atoms, a silicon-containing group, or a hetero atom-containing group, but it is necessary that at least one of them does not represent a hydrogen atom.

Also, R⁴ to R⁹ may be the same or different, and the adjacent groups may be bonded to each other to form a ring.

Above all, it is preferable that R⁶ and R⁷ form a ring and that R⁸ and R⁹ form a ring because the polymerization activity becomes higher.

As R⁴ and R⁵, a group containing a hetero atom such as oxygen, a halogen, and silicon is preferable because the polymerization activity becomes higher.

It is preferable that this metallocene complex containing, as a ligand, a double-crosslinked biscyclopentadienyl derivative contains silicon in the crosslinking group between the ligands.

Specific examples of the double-crosslinked metallocene complex represented by the general formula (I) include (1,2′-ethylene)(2,1′-ethylene)-bis(indenyl)zirconium dichloride, (1,2′-methylene)(2,1′-methylene)-bis(indenyl)-zirconium dichloride, (1,2′-isopropylidene)(2,1′-isopropylidene)-bis(indenyl)zirconium dichloride, (1,2′-ethylene) (2,1′-ethylene)-bis(3-methylindenyl)zirconium dichloride, (1,2′-ethylene)(2,1′-ethylene)-bis(4,5-benzoindenyl)zirconium dichloride, (1,2′-ethylene)(2,1′-ethylene)-bis(4-isopropylindenyl) zirconium dichloride, (1,2′-ethylene) (2,1′-ethylene)-bis(5,6-dimethylindenyl)-zirconium dichloride, (1,2′-ethylene) (2,1′-ethylene)-bis-(4,7-diisopropylindenyl)zirconium dichloride, (1,2′-ethylene)(2,1′-ethylene)-bis(4-phenylindenyl) zirconium dichloride, (1,2′-ethylene) (2,1′-ethylene)-bis(3-methyl-4-isopropylindenyl)zirconium dichloride, (1,2′-ethylene)(2,1′-ethylene)-bis(5,6-benzoindenyl)zirconium dichloride, (1,2′-ethylene)(2,1′-isopropylidene)-bis(indenyl) zirconium dichloride, (1,2′-methylene)(2,1′-ethylene)-bis (indenyl)zirconium dichloride, (1,2′-methylene) (2,1′-isopropylidene)-bis(indenyl)zirconium dichloride, (1,2′-dimethylsilylene)(2,1′-dimethylsilylene)bis(indenyl) zirconium dichloride, (1,2′-dimethylsilylene)(2,1′-dimethylsilylene)bis(3-methylindenyl)zirconium dichloride, (1,2′-dimethylsilylene)(2,1′-dimethylsilylene)bis(3-n-butyl-indenyl)zirconium dichloride, (1,2′-dimethylsilylene) (2,1′-dimethylsilylene)bis(3-isopropylindenyl)zirconium dichloride, (1,2′-dimethylsilylene)(2,1′-dimethylsilylene) bis(3-trimethylsilylmethylindenyl)zirconium dichloride, (1,2′-dimethylsilylene)(2,1′-dimethylsilylene)bis(3-phenylindenyl)zirconium dichloride, (1,2′-dimethylsilylene) (2,1′-dimethylsilylene)bis(4,5-benzoindenyl)zirconium dichloride, (1,2′-dimethylsilylene)(2,1′-dimethylsilylene) bis(4-isopropylindenyl) zirconium dichloride, (1,2′-dimethylsilylene)(2,1′-dimethylsilylene)bis(5,6-dimethylindenyl) zirconium dichloride, (1,2′-dimethylsilylene)(2,1′-dimethylsilylene)bis(4,7-diisopropylindenyl)zirconium dichloride, (1,2′-dimethylsilylene)(2,1′-dimethylsilylene)bis(4-phenylindenyl)zirconium dichloride, (1,2′-dimethylsilylene) (2,1′-dimethylsilylene)bis(3-methyl-4-isopropylindenyl) zirconium dichloride, (1,2′-dimethylsilylene)(2,1′-dimethylsilylene)bis(5,6-benzoindenyl)zirconium dichloride, (1,2′-dimethylsilylene)(2,1′-isopropylidene)-bis(indenyl)-zirconium dichloride, (1,2′-dimethylsilylene) (2,1′-isopropylidene)-bis(3-methylindenyl)zirconium dichloride, (1,2′-dimethylsilylene)(2,1′-isopropylidene)-bis(3-isopropylindenyl)zirconium dichloride, (1,2′-dimethylsilylene) (2,1′-isopropylidene)-bis(3-n-butylindenyl)zirconium dichloride, (1,2′-dimethylsilylene)(2,1′-isopropylidene)-bis(3-trimethylsilylmethylindenyl)zirconium dichloride, (1,2′-dimethylsilylene)(2,1′-isopropylidene)-bis(3-trimethylsilylindenyl)zirconium dichloride, (1,2′-dimethylsilylene)-(2,1′-isopropylidene)-bis-(3-phenylindenyl)zirconium dichloride, (1,2′-dimethylsilylene)-(2,1′-methylene)-bis-(indenyl)zirconium dichloride, (1,2′-dimethylsilylene)-(2,1′-methylene)-bis(3-methylindenyl)zirconium dichloride, (1,2′-dimethylsilylene) (2,1′-methylene)-bis(3-isopropylindenyl)zirconium dichloride, (1,2′-dimethylsilylene) (2,1′-methylene)-bis(3-n-butylindenyl)zirconium dichloride, (1,2′-dimethylsilylene)(2,1′-methylene)-bis(3-trimethylsilylmethylindenyl)zirconium dichloride, (1,2′-dimethylsilylene)(2,1′-methylene)-bis(3-trimethylsilylindenyl)-zirconium dichloride, (1,2′-diphenylsilylene)(2,1′-methylene)-bis(indenyl)zirconium dichloride, (1,2′-diphenylsilylene) (2,1′-methylene)-bis(3-methylindenyl)zirconium dichloride, (1,2′-diphenylsilylene)(2,1′-methylene)-bis(3-isopropylindenyl)zirconium dichloride, (1,2′-diphenylsilylene) (2,1′-methylene)-bis(3-n-butylindenyl)zirconium dichloride, (1,2′-diphenylsilylene)(2,1′-methylene)-bis(3-trimethylsilylmethylindenyl)zirconium dichloride, (1,2′-diphenylsilylene)(2,1′-methylene)-bis(3-trimethylsilylindenyl) zirconium dichloride, (1,2′-dimethylsilylene)(2,1′-dimethylsilylene)(3-methylcyclopentadienyl)(3′-methyl cyclopentadienyl)zirconium dichloride, (1,2′-dimethylsilylene) (2,1′-isopropylidene)(3-methylcyclopentadienyl)(3′-methylcyclopentadienyl)zirconium dichloride, (1,2′-dimethylsilylene) (2,1′-ethylene)(3-methylcyclopentadienyl)(3′-methylcyclopentadienyl)zirconium dichloride, (1,2′-ethylene) (2,1′-methylene)(3-methylcyclopentadienyl)(3′-methylcyclopentadienyl)zirconium dichloride, (1,2′-ethylene) (2,1′-isopropylidene)(3-methylcyclopentadienyl)(3′-methylcyclopentadienyl)zirconium dichloride, (1,2′-methylene) (2,1′-methylene) (3-methylcyclopentadienyl) (3′-methyl cyclopent adienyl)zirconium dichloride, (1,2′-methylene)(2,1′-isopropylidene)(3-methylcyclopentadienyl)(3′-methylcyclopentadienyl)zirconium dichloride, (1,2′-isopropylidene)(2,1′-isopropylidene)(3-methylcyclopentadienyl)(3′-methylcyclopentadienyl)zirconium dichloride, (1,2′-dimethylsilylene)(2,1′-dimethylsilylene)(3,4-dimethylcyclopentadienyl)(3′,4′-dimethylcyclopentadienyl)zirconium dichloride, (1,2′-dimethylsilylene)(2,1′-isopropylidene) (3,4-dimethylcyclopentadienyl)(3′,4′-dimethylcyclopentadienyl)zirconium dichloride, (1,2′-dimethylsilylene) (2,1′-ethylene)(3,4-dimethylcyclopentadienyl)(3′,4′-dimethylcyclopentadienyl)zirconium dichloride, (1,2′-ethylene) (2,1′-methylene)(3,4-dimethylcyclopentadienyl) (3′,4′-dimethylcyclopentadienyl)zirconium dichloride, (1,2′-ethylene)(2,1′-isopropylidene)(3,4-dimethylcyclopentadienyl)(3′,4′-dimethylcyclopentadienyl)zirconium dichloride, (1,2′-methylene)(2,1′-methylene)(3,4-dimethylcyclopentadienyl)(3′,4′-dimethylcyclopentadienyl)zirconium dichloride, (1,2′-methylene)(2,1′-isopropylidene)(3,4-dimethylcyclopentadienyl)(3′,4′-dimethylcyclopentadienyl)zirconium dichloride, (1,2′-isopropylidene)(2,1′-isopropylidene)(3,4-dimethylcyclop entadienyl)(3′,4′-dimethylcyclopentadienyl)zirconium dichloride, (1,2′-dimethylsilylene)(2,1′-dimethylsilylene)(3-methyl-5-ethylcyclopentadienyl)(3′-methyl-5′-ethylcyclopentadienyl) zirconium dichloride, (1,2′-dimethylsilylene) 2,1′-dimethylsilylene)(3-methyl-5-ethylcyclopentadienyl)(3′-methyl-5′-ethylcyclopentadienyl)zirconium dichloride, (1,2′-dimethylsilylene)(2,1′-dimethylsilylene)(3-methyl-5-isopropylcyclopentadienyl)(3′-methyl-5′-isopropylcyclopentadienyl)zirc onium dichloride, (1,2′-dimethylsilylene)(2,1′-dimethylsilylene)(3-methyl-5-n-butylcyclopentadienyl)(3′-methyl-5′-n-butylcyclopentadienyl)zirconium dichloride, (1,2′-dimethylsilylene)(2,1′-dimethylsilylene)(3-methyl-5-phenylcyclopendienyl)(3′-methyl-5′-phenylcyclopentadienyl) zirconium dichloride, (1,2′-dimethylsilylene) (2,1′-isopropylidene)(3-methyl-5-ethylcyclopentadienyl) (3′-methyl-5′-ethylcyclopentadienyl)zirconium dichloride, (1,2′-dimethylsilylene)(2,1′-isopropylidene)(3-methyl-5-isopropylcyclopentadienyl)(3′-methyl-5′-isopropylcyclopentadienyl)zirconium dichloride, (1,2′-dimethylsilylene) (2,1′-isopropylidene)(3-methyl-5-n-butylcyclopentadienyl) (3′-methyl-5′-n-butylcyclopentadienyl)zirconium dichloride, (1,2′-dimethylsilylene)(2,1′-isopropylidene)(3-methyl-5-phenylcyclopentadienyl)(3′-methyl-5′-phenylcyclopentadienyl)zirconium dichloride, (1,2′-dimethylsilylene) (2,1′-ethylene)(3-methyl-5-ethylcyclopentadienyl)(3′-methyl-5′-ethylcyclopentadienyl)zirconium dichloride, (1,2′-dimethylsilylene)(2,1′-ethylene)(3-methyl-5-isopropylcyclopentadienyl)(3′-methyl-5′-isopropylcyclopentadienyl)zirconium dichloride, (1,2′-dimethylsilylene)(2,1′-ethylene)(3-methyl-5-n-butylcyclopentadienyl)(3′-methyl-5′-n-butylcyclopentadienyl)zirconium dichloride, (1,2′-dimethylsilylene) (2,1′-ethylene)(3-methyl-5-phenylcyclopentadienyl)(3′-methyl-5′-phenylcyclopentadienyl)zirconium dichloride, (1,2′-dimethylsilylene)(2,1′-methylene)(3-methyl-5-ethylcyclo pentadienyl)(3′-methyl-5′-ethylcyclopentadienyl)zirconium dichloride, (1,2′-dimethylsilylene)(2,1′-methylene)(3-methyl-5-isopropylcyclopentadienyl)(3′-methyl-5′-isopropylcyclopentadienyl)zirconium dichloride, (1,2′-dimethylsilylene)(2,1′-methylene)(3-methyl-5-n-butylcyclopentadienyl) (3′-methyl-5′-n-butylcyclopentadienyl)zirconium dichloride, (1,2′-dimethylsilylene)(2,1′-methylene)(3-methyl-5-phenylcyclopentadienyl)(3′-methyl-5′-phenylcyclopentadienyl)zirconium dichloride, (1,2′-ethylene)(2,1′-methylene) (3-methyl-5-isopropylcyclopentadienyl)(3′-methyl-5′-isopropylcyclopentadienyl)zirconium dichloride, (1,2′-ethylene)(2,1′-isopropylidene)(3-methyl-5-isopropylcyclopentadienyl)(3′-methyl-5′-isopropylcyclopentadienyl) zirconium dichloride, (1,2′-methylene)(2,1′-methylene) (3-methyl-5-isopropylcyclopentadienyl)(3′-methyl-5′-isopropylcyclopentadienyl)zirconium dichloride, (1,2′-methylene)(2,1′-isopropylidene)(3-methyl-5-isopropylcyclopentadienyl)(3′-methyl-5′-isopropylcyclopentadienyl) zirconium dichloride, (1,1′-dimethylsilylene)(2,2′-dimethylsilylene)bisindenylzirconium dichloride, (1,1′-diphenylsilylene) (2,2′-dimethylsilylene)bisindenylzirconium dichloride, (1,1′-dimethylsilylene) (2,2′-dimethylsilylene) bisindenylzirconium dichloride, (1,1′-diisopropylsilylene) (2,2′-dimethylsilylene)bisindenylzirconium dichloride, (1,1′-dimethylsilylene)(2,2′-diisopropylsilylene)bisindenylzirconium dichloride, (1,1′-dimethylsilyleneindenyl) (2,2′-dimethylsilylene-3-trimethylsilylindenyl)zirconium dichloride, (1,1′-diphenylsilyleneindenyl)(2,2′-diphenylsilylene-3-trimethylsilylindenyl)zirconium dichloride, (1,1′-diphenylsilyleneindenyl)(2,2′-dimethylsilylene-3-trimethylsilylindenyl)zirconium dichloride, (1,1′-dimethylsilyleneindenyl)(2,2′-diphenylsilylene-3-trimethylsilylindenyl)zirconium dichloride, (1,1′-diisopropylsilyleneindenyl)(2,2′-dimethylsilylene-3-trimethylsilylindenyl)zirconium dichloride, (1,1′-dimethylsilyleneindenyl)(2,2′-diisopropylsilylene-3-trimethylsilylindenyl)zirconium dichloride, (1,1′-diisopropylsilyleneindenyl)(2,2′-diisopropylsilylene-3-trimethylsilylindenyl)zirconium dichloride, (1,1′-dimethylsilyleneindenyl)(2,2′-dimethylsilylene-3-trimethylsilylmethylindenyl)zirconium dichloride, (1,1′-diphenylsilyleneindenyl)(2,2′-diphenylsilylene-3-trimethylsilylmethylindenyl) zirconium dichloride, (1,1′-diphenylsilyleneindenyl) (2,2′-dimethylsilylene-3-trimethylsilylmethylindenyl) zirconium dichloride, (1,1′-dimethylsilyleneindenyl) (2,2′-diphenylsilylene-3-trimethylsilylmethylindenyl) zirconium dichloride, (1,1′-diisopropylsilyleneindenyl) (2,2′-dimethylsilylene-3-trimethylsilylmethylindenyl) zirconium dichloride, (1,1′-dimethylsilyleneindenyl) (2,2′-diisopropylsilylene-3-trimethylmethylsilylindenyl) zirconium dichloride, and (1,1′-diisopropylsilyleneindenyl) (2,2′-diisopropylsilylene-3-trimethylmethylsilylindenyl)zirco nium dichloride; and compounds obtained by substituting zirconium of these compounds with titanium or hafnium.

As a matter of course, it should not be construed that the present invention is limited thereto.

Also, analogous compounds of a metal element of other group or the lanthanoid series may be used.

Also, in the foregoing compounds, the (1,1′-)(2,2′-) may be substituted with (1,2′-)(2,1′-); and the (1,2′-)(2,1′-) may be substituted with (1,1′-)(2,2′-).

Examples of the solid organoboron compound capable of forming an ion pair with the compound (A), which is used as the component (B) in the present invention, include coordination complex compounds composed of an anion and a cation in which plural groups are bound to a metal.

The coordination complex compound composed of an anion and a cation in which plural groups are bonded to a metal includes various compounds, and for example, compounds represented by the general formula (III) or (IV) can be preferably used.

([L¹-H]^{s+})ₜ([BZ¹Z²Z³Z⁴]⁻)₁ (III)

([L²]^{s+})ₜ([BZ¹Z²Z³Z⁴]⁻)₁ (IV)

[In the formula (III) or (IV), L² represents M¹, R¹⁰R¹¹M², or R¹²₃C as described later; L¹ represents a Lewis base; M¹ represents a metal selected from those of the group 1 and the groups 8 to 12 of the periodic table; M² represents a metal selected from those of the groups 8 to 10 of the periodic table; and Z¹ to Z⁴ each represents a hydrogen atom, a dialkylamino group, an alkoxy group, an aryloxy group, an alkyl group having from 1 to 20 carbon atoms, an aryl group having from 6 to 20 carbon atoms, an alkylaryl group, an arylalkyl group, a substituted alkyl group, an organic metalloid group, or a halogen atom.

R¹⁰ and R¹¹ each represent a cyclopentadienyl group, a substituted cyclopentadienyl group, an indenyl group, or a fluorenyl group; and R¹² represents an alkyl group.

s represents an ionic charge of L¹-H or L² and an integer of from 1 to 7; t represents an integer of 1 or more; and l=t×s.]

M¹ represents a metal selected from those of the group 1 and the groups 8 to 12 of the periodic table, and specific examples thereof include respective atoms such as Ag, Cu, Na, and Li; and M² represents a metal selected from those of the groups 8 to 10 of the periodic table, and specific examples thereof include respective atoms such as Fe, Co, and Ni.

Specific examples of Z¹ to Z⁴ include a dimethylamino group and a diethylamino group as the dialkylamino group; a methoxy group, an ethoxy group, and an n-butoxy group as the alkoxy group; a phenoxy group, a 2,6-dimethylphenoxy group, and a naphthyloxy group as the aryloxy group; a methyl group, an ethyl group, an n-propyl group, an isopropyl group, an n-butyl group, an n-octyl group, and a 2-ethylhexyl group as the alkyl group having from 1 to 20 carbon atoms; a phenyl group, a p-tolyl group, a benzyl group, a pentafluorophenyl group, a 3,5-di(trifluoromethyl)phenyl group, a 4-tert-butylphenyl group, a 2,6-dimethylphenyl group, a 3,5-dimethylphenyl group, a 2,4-dimethylphenyl group, and a 1,2-dimethylphenyl group as the aryl group having from 6 to 20 carbon atoms, the alkylaryl group or the arylalkyl group; F, Cl, Br, and I as the halogen; and a tetramethylantimony group, a trimethylsilyl group, a trimethylgermyl group, a diphenylarsine group, a dicyclohexylantimony group, and a diphenylboron group as the organic metalloid group.

Specific examples of the substituted cyclopentadienyl group represented by each of R¹⁰ and R¹¹ include a methylcyclopentadienyl group, a butylcyclopentadienyl group, and a pentamethyl cyclopentadienyl group.

In the present invention, specific examples of the anion in which plural groups are bonded to a metal include B(C₆F₅)₄⁻, B(C₆HF₄)₄⁻, B(C₆H₂F₃)₄⁻, B(C₆H₃F₂)₄⁻, B(C₆H₄F)₄⁻, B(C₆CF₃F₄)₄⁻, B(C₆H₅)₄⁻, and BF₄⁻.

Also, examples of the metal cation include Cp₂Fe⁺, (MeCp)₂Fe⁺, (tBuCp)₂Fe⁺, (Me₂ Cp)₂Fe⁺, (Me₃ Cp)₂Fe⁺, (Me₄ Cp)₂Fe⁺, (Me₅ Cp)₂Fe⁺, Ag⁺, Na⁺, and Li⁺. Also, examples of other cation include nitrogen-containing compounds such as pyridinium, 2,4-dinitro-N,N-diethylanilinium, diphenylammonium, p-nitroanilinium, 2,5-dichloroaniline, p-nitro-N,N-dimethylanilinium, quinolinium, N,N-dimethylanilinium, and N,N-diethylanilinium; carbenium compounds such as triphenyl-carbenium, tri(4-methylphenyl)carbenium, and tri(4-methoxyphenyl)carbenium; alkylphosphonium ions such as CH₃PH₃⁺, C₂H₅PH₃⁺, C₃H₇PH₃⁺, (CH₃)₂PH₂⁺, (C₂H₅)₂PH₂⁺, (C₃H₇)₂PH₂⁺, (CH₃)₃PH⁺, (C₂H₅)₃PH⁺, (C₃H₇)₃PH⁺, (CF₃)₃PH⁺, (CH₃)₄P⁺, (C₂H₅)₄P⁺, and (C₃H₇)₄P⁺; and arylphosphonium ions such as C₆H₅PH₃⁺, (C₆H₅)₂PH₂⁺, (C₆H₅)₃PH⁺, (C₆H₅)₄P⁺, (C₂H₅)₂ (C₆H₅)PH⁺, (CH₃) (C₆H₅) PH₂⁺, (CH₃)₂(C₆H₅)PH⁺, and (C₂H₅)₂(C₆H₅)₂P⁺.

In the present invention, coordination complex compounds composed of an arbitrary combination of the foregoing metal cation and anion are exemplified.

Of the compounds represented by the general formulae (III) and (IV), the following can be especially preferably used.

Examples of the compound represented by the general formula (III) include triethylammonium tetraphenylborate, tri(n-butyl)ammonium tetraphenylborate, trimethylammonium tetraphenylborate, triethylammonium tetrakis(pentafluorophenyl)borate, tri(n-butyl)ammonium tetrakis(pentafluorophenyl)borate, triethylammonium hexafluoroarsenate, pyridinium tetrakis(pentafluorophenyl)borate, pyrrolinium tetrakis(pentafluorophenyl)borate, N,N-dimethylanilinium tetrakis(pentafluorophenyl)borate, and methyldiphenylammonium tetrakis(pentafluorophenyl)borate.

On the other hand, examples of the compound represented by the general formula (IV) include ferrocenium tetraphenylborate, dimethylferrocenium tetrakis(pentafluorophenyl)borate, ferrocenium tetrakis(pentafluorophenyl)borate, decamethylferrocenium tetrakis(pentafluorophenyl)borate, acetylferrocenium tetrakis(pentafluorophenyl)borate, formylferrocenium tetrakis(pentafluorophenyl)borate, cyanoferrocenium tetrakis(pentafluorophenyl)borate, silver tetraphenylborate, silver tetrakis(pentafluorophenyl)borate, trityl tetraphenylborate, trityl tetrakis(pentafluorophenyl)borate, and silver tetrafluoroborate.

A preferred coordination complex compound is a compound composed of a non-coordinating anion and a substituted triarylcarbenium; and examples of the non-coordinating anion include compounds represented by the general formula (V).

(BZ¹Z²Z³Z⁴)⁻ (V)

[In the formula, Z¹ to Z⁴ each represents a hydrogen atom, a dialkylamino group, an alkoxy group, an aryloxy group, an alkyl group having from 1 to 20 carbon atoms, an aryl group having from 6 to 20 carbon atoms (including a halogen-substituted aryl group), an alkylaryl group, an arylalkyl group, a substituted alkyl group, an organic metalloid group, or a halogen atom.]

On the other hand, examples of the substituted triarylcarbenium include compounds represented by the general formula (VI).

[CR¹³R¹⁴R¹⁵]⁺ (VI)

In the general formula (VI), R¹³, R¹⁴ and R¹⁵ each represents an aryl group such as a phenyl group, a substituted phenyl group, a naphthyl group, and an anthracenyl group, and R¹³, R¹⁴ and R¹⁵ may be the same or different, provided that at least one of them represents a substituted phenyl group, a naphthyl group, or an anthracenyl group.

Examples of the substituted phenyl group include groups represented by the general formula (VII).

C₆H₅₋ₖR¹⁶k (VII)

In the general formula (VII), R¹⁶ represents a hydrocarbyl group having from 1 to 10 carbon atoms, an alkoxy group, an aryloxy group, a thioalkoxy group, a thioaryloxy group, an amino group, an amide group, a carboxyl group, or a halogen atom; and k represents an integer of from 1 to 5.

When k is 2 or more, plural R¹⁶s may be the same or different.

Specific examples of the non-coordinating anion represented by the general formula (V) include tetra(fluorophenyl)borate, tetrakis(difluorophenyl)borate, tetrakis(trifluorophenyl) borate, tetrakis(tetrafluorophenyl)borate, tetrakis (pentafluorophenyl)borate, tetrakis(trifluoromethylphenyl) borate, tetra(toluoyl)borate, tetra(xylyl)borate, (triphenyl, pentafluorophenyl)borate, [tris(pentafluorophenyl), phenyl] borate, and tridecahydride-7,8-dicarbaundecaborate.

Also, specific examples of the substituted triarylcarbenium represented by the general formula (VI) include tri(toluoyl)carbenium, tri(methoxyphenyl)carbenium, tri(chlorophenyl)carbenium, tri(fluorophenyl)carbenium, tri(xylyl)carbenium, [di(toluoyl), phenyl]carbenium, [di(methoxyphenyl), phenyl]carbenium, [di(chlorophenyl), phenyl]carbenium, [toluoyl, di(phenyl)]carbenium, [methoxyphenyl, di(phenyl)]carbenium, and [chlorophenyl, di(phenyl)]carbenium.

The catalysts employed in the present invention are, in addition to the foregoing component (A) and component (B), an organoaluminum compound as the component (C).

Examples of the organoaluminum compound (C) include compounds represented by the general formula (VIII).

R²⁰ᵥAlJ₃₋ᵥ (VIII)

[In the formula, R²⁰ represents an alkyl group having from 1 to 10 carbon atoms; J represents a hydrogen atom, an alkoxy group having from 1 to 20 carbon atoms, an aryl group having from 6 to 20 carbon atoms, or a halogen atom; and v represents an integer of from 1 to 3.]

Specific examples of the compound represented by the general formula (VIII) include trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride, and ethylaluminum sesquichloride.

These organoaluminum compounds may be used singly or in combination of two or more kinds thereof.

Examples of the organoaluminum compound as the component (C) include chain aluminoxanes represented by the general formula (IX) and cyclic aluminoxanes represented by the general formula (X).

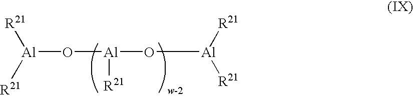

(In the formula, R²¹ represents a hydrocarbon group having from 1 to 20 carbon atoms, and preferably from 1 to 12 carbon atoms, such as an alkyl group, an alkenyl group, an aryl group, and an arylalkyl group, or a halogen atom; w represents an average degree of polymerization and is usually an integer of from 2 to 50, and preferably from 2 to 40; and respective R²¹s may be the same or different.)

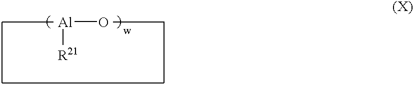

(In the formula, R²¹ and w are the same as those in the foregoing general formula (IX).)

Examples of the compounds represented by the general formulae (IX) and (X) include linear or cyclic alumoxanes such as tetramethyldialumoxane, tetraisobutyldialumoxane, methylalumoxane, ethylalumoxane, butylalumoxane, and isobutylalumoxane.

Though a method of bringing an alkylaluminum into contact with a condensing agent such as water is mentioned as a method for producing an aluminoxane, its means is not particularly limited but the reaction may be achieved pursuant to a known method.

These aluminoxanes may be used singly or in combination of two or more kinds thereof.

The component (D) which is used in the present invention is one or two or more kinds of compounds selected from an α-olefin, an internal olefin and a polyene.

Examples of the internal olefin include 2-butene, 2-pentene, 2-hexene, 3-hexene, 2-heptene, 3-heptene, 2-octene, 3-octene, 4-octene, and 5-decene.

Examples of the polyene include diene compounds such as 1,3-butadiene, 1,5-hexadiene, and 1,7-octadiene.

Examples of the α-olefin include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene.

One or two or more kinds of these compounds can be used.

The component (D) is preferably an α-olefin, and especially preferably an α-olefin having from 3 to 30 carbon atoms in view of enhancing the catalytic activity.

Here, when an α-olefin having a boiling point of 50° C. or higher under atmospheric pressure (1-pentene or higher) is used in the preparation of a catalyst, a reaction tank which is used in the preparation of a catalyst is not required to have pressure resistance; the possibility that a poly-α-olefin (preliminarily polymerized polymer) is precipitated at the preservation after the preparation of a catalyst is lowered; and troubles such as clogging of a pump caused at the transfer of the prepared catalyst can be prevented.

In the present invention, when the component (D) is a liquid, the hydrocarbon based solvent as the component (E) is not an essential component.

But, by bringing the components (A) to (D) into contact with each other in the presence of the hydrocarbon based solvent as the component (E), it becomes easy to produce a preliminarily polymerized polymer as described later, with respect to, for example, control of intrinsic viscosity and preparation of a homogenous catalyst.

Examples of the hydrocarbon based solvent which is used in the present invention include aromatic hydrocarbons such as benzene, toluene, xylene, and ethylbenzene; alicyclic hydrocarbons such as cyclopentane, cyclohexane, methylcyclohexane, ethylcyclohexane, decalin, and tetralin; aliphatic hydrocarbons such as pentane, hexane, heptane, and octane; and halogenated hydrocarbons such as chloroform and dichloromethane. These solvents may be used singly or in combination of two or more kinds thereof.

In view of safety and hygiene, it is preferred to use an aliphatic hydrocarbon based solvent or an alicyclic hydrocarbon based solvent as the hydrocarbon based solvent as the component (E).

Representative examples of the preparation method of the polymerization catalyst of the invention are described.

For example, (D) one or two or more kinds of compounds selected from an α-olefin, an internal olefin and a polyene and (C) an organoaluminum compound are added in a hydrocarbon based solvent; and (A) a transition metal compound and (B) a solid organoboron compound capable of forming an ion pair with the component (A) are then added and brought into contact with each other.

In that case, when the component (D) is a polymerizable compound, this contact is a preliminary polymerization treatment.

There are no limitations with respect to the addition order of the component (D) and the component (C) and the addition order of the component (A) and the component (B).

Also, on that occasion, hydrogen of from 0.005 to 1.0 MPa can be made coexistent.

A temperature at the contact (preliminary polymerization) is usually from −20 to 200° C., preferably from −10 to 150° C., and more preferably from 0 to 80° C.

A time at the contact (preliminary polymerization) is usually from 10 minutes to 30 days, and preferably from one hour to 15 days.

The component (A) and the component (B) react with each other while being dissolved in a solvent, thereby forming an active point.

For that reason, the catalytic activity is effectively enhanced by homogenizing the catalyst system.

Accordingly, when the time at contact (preliminary polymerization) is too short, the enhancement of the catalytic activity is not sufficient.

On the other hand, when the time at contact (preliminary polymerization) is too long, the catalytic activity may possibly be lowered.

A use proportion (molar ratio) of the component (A) to the component (B) is preferably from 1/100 to 1/1, and more preferably from 1/10 to 1/1.

When the ratio of the component (A) to the component (B) is less than 1/100, the component (B) is wasted, whereas when it exceeds 1/1, the activity may possibly be not sufficient.

Also, a use proportion (molar ratio) of the component (A) to the component (C) is preferably from 1/10,000 to 1/1, and more preferably from 1/2,500 to 1/5.

When the ratio of the component (A) to the component (C) is less than 1/10,000, the component (C) is wasted, whereas when it exceeds 1/5, the activity may possibly be not sufficient.

A use amount of the component (D) is from 10 to 100,000, and preferably from 100 to 100,000 in terms of a ratio of the component (D) to the component (A) [molar ratio].

When this ratio is less than 10, the polymerization activity may possibly be not sufficient, whereas when it exceeds 100,000, the polymerization activity may possibly be lowered.

When an α-olefin is used as the component (D), an intrinsic viscosity of the poly-α-olefin (preliminarily polymerized polymer) formed by the preliminary polymerization is preferably 0.05 dL/g or more and less than 15 dL/g.

This upper limit value is more preferably less than 10 dL/g, and further preferably less than 5 dL/g.

When the intrinsic viscosity exceeds 15 dL/g, a viscosity of the polymerization catalyst solution increases, and the feed of the polymerization catalyst solution into the polymerization system may possibly be impaired.

Incidentally, measurement of the intrinsic viscosity [η] was carried out in a decalin solvent at a temperature of 135° C. by using a VMR-053 Model automatic viscometer as manufactured by Rigo Co., Ltd.

In the foregoing preparation method of a catalyst, when an aromatic hydrocarbon is used as a solvent, a homogeneous polymerization catalyst is usually obtained. However, when not only the ratio of the component (B) to the component (A) (molar ratio) is 5 or more but also a concentration of the component (A) is 10 μmoles/mL or more, a heterogeneous catalyst is easily formed.

Also, when an alicyclic hydrocarbon or an aliphatic hydrocarbon is used as a solvent, since the solubility of the component (A) and the component (B) is low, a formed catalyst is easy to become heterogeneous.

As the α-olefin having from 3 to 30 carbon atoms which is used in the main polymerization of the present invention, the same α-olefins as those in the component (D) can be mentioned.

Examples thereof include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene; and one or two or more thereof can be used.

The main polymerization reaction condition of an α-olefin by using the polymerization catalyst obtained by bringing the component (A), the component (B), the component (C) and the component (D) of the present invention into contact with each other is described.

A polymerization temperature is usually from −100 to 250° C., preferably from −50 to 200° C., and more preferably from 0 to 130° C.

A polymerization pressure is preferably from atmospheric pressure to 20 MPa (gauge), and more preferably from atmospheric pressure to 10 MPa (gauge).

A polymerization time is usually from 5 minutes to 15 hours.

The ratio of the α-olefin having from 3 to 30 carbon atoms to the component (A) in the polymerization catalyst [molar ratio] is preferably from 1 to 10⁸, and more preferably from 100 to 10⁵.

Also, in the main polymerization, the foregoing component (C) may be further added to the polymerization catalyst obtained by bringing the component (A), the component (B), the component (C) and the component (D) of the present invention into contact with each other.

Examples of the preferred organoaluminum compound as the component (C) include trialkylaluminums such as trimethylaluminum, triethylaluminum, triisobutylaluminum, and trioctylaluminum; and alumoxanes such as tetraisobutylalumoxane, methylalumoxane, and isobutylalumoxane.

Furthermore, examples of a method of adjusting the molecular weight of the poly-α-olefin include selection of the kind and use amount of each of the catalyst components and the polymerization temperature and polymerization in the presence of hydrogen.

As the main polymerization method, bulk polymerization, solution polymerization and suspension polymerization are employable.

As a polymerization solvent, hydrocarbon based solvents the same as those used in the catalyst preparation can optionally be used.

Examples thereof include aromatic hydrocarbons such as benzene, toluene, xylene, and ethylbenzene; alicyclic hydrocarbons such as cyclopentane, cyclohexane, and methylcyclohexane; aliphatic hydrocarbons such as pentane, hexane, heptane, and octane; and halogenated hydrocarbons such as chloroform and dichloromethane.

These solvents may be used singly or in combination of two or more kinds thereof.

Also, monomers such as α-olefins may be used as the solvent.

Incidentally, the polymerization can be carried out in the absence of a solvent depending upon the polymerization method.

### EXAMPLES

Next, the present invention is described in more detail with reference to the Examples, but it should not be construed that the present invention is limited thereto.

### Comparative Example 1

### Preparation of Catalyst

In a 50 mL Schlenk bottle, dehydrated toluene (8 mL) was added at 25° C. in a stream of nitrogen.

Next, a heptane solution of triisobutylaluminum (0.1 mL, 2 M), a toluene solution of (1,2′-dimethylsilylene)-(2,1′-dimethylsilylene)bis(3-trimethylsilylmethyl-indenyl) zirconium dichloride (1.0 mL, 10 μmoles/mL) of Referential Example 1 and a heptane slurry of dimethylanilinium tetrakis-(pentafluorophenyl)borate (1.0 mL, 20 μmoles/mL) were successively added with stirring.

Thereafter, the stirring was continued for 24 hours to obtain a homogeneous catalyst solution.

### (Polymerization)

In a 1 L autoclave, LINEALENE 18 (400 mL) as manufactured by Idemitsu Kosan Co., Ltd. was introduced in a stream of nitrogen, and a heptane solution of triisobutylaluminum (2 M, 0.5 mmoles, 1.0 mL) was introduced at 25° C.

Next, the temperature was increased to 70° C. over 5 minutes; and after introducing the catalyst solution (1.0 mL) obtained above, hydrogen was continuously introduced such that a hydrogen partial pressure was 0.05 MPa.

After reacting for one hour, methanol (3 mL) was introduced, followed by depressurization.

The resulting polymerization solution was introduced into acetone (200 mL) to precipitate a deposit.

This deposit was heat dried to obtain 146 g of a desired polymer.

Its catalytic activity was 1,600 kg/g-Zr·h.

### Example 1

### Preparation of Catalyst 1

In a 50 mL Schlenk bottle, dehydrated toluene (7 mL) was added at 25° C. in a stream of nitrogen.

Next, a heptane solution of triisobutylaluminum (0.1 mL, 2 M), LINEALENE 18 (major component: 1-octadecene) (1.0 mL) as manufactured by Idemitsu Kosan Co., Ltd., a toluene solution of (1,2′-dimethylsilylene)(2,1′-dimethylsilylene)bis (3-trimethylsilylmethyl-indenyl)zirconium dichloride (1.0 mL, 10 μmoles/mL) of Referential Example 1 and a heptane slurry of dimethylanilinium tetrakis(pentafluorophenyl)borate (1.0 mL, 20 μmoles/mL) were added in this order with stirring, and the stirring was continued for 24 hours.

1 mL of the resulting catalyst homogenous solution was introduced into 10 mL of acetone; and a deposit was dried under reduced pressure to obtain 0.1 g of a polymer.

This had an intrinsic viscosity [η] of 0.17 dL/g.

### (Polymerization)

In a 1 L autoclave, LINEALENE 18 (major component: 1-octadecene) (400 mL) as manufactured by Idemitsu Kosan Co., Ltd. was introduced in a stream of nitrogen, and a heptane solution of triisobutylaluminum (2 M, 0.5 mmoles, 1.0 mL) was introduced at 25° C.

Next, the temperature was increased to 70° C. over 5 minutes; and after introducing the foregoing catalyst solution (1.0 mL), the mixture was allowed to react continuously while adjusting a hydrogen partial pressure at 0.05 MPa.

After reacting for one hour, methanol (3 mL) was introduced, followed by depressurization.

The resulting polymerization reaction solution was introduced into acetone (200 mL) to precipitate a deposit.

This deposit was heat dried to obtain 227 g of a desired polymer.

Its catalytic activity was 2,490 kg/g-Zr·h.

### Comparative Example 2

In a 1 L autoclave, LINEALENE 18 (major component: 1-octadecene) (400 mL) as manufactured by Idemitsu Kosan Co., Ltd. and a heptane solution of triisobutylaluminum (2 M, 1.0 mmole, 0.5 mL) were introduced at 25° C. in a stream of nitrogen.

Next, the temperature was increased to 70° C. over 5 minutes, and a toluene solution of (1,2′-dimethylsilylene)-(2,1′-dimethylsilylene)bis(3-trimethylsilylmethyl-indenyl) zirconium dichloride (0.1 mL, 10 μmoles/mL) of Referential Example 1 and a heptane slurry of dimethylanilinium tetrakis (pentafluorophenyl)borate (0.2 mL, 20 μmoles/mL) were introduced.

The mixture was allowed to react continuously while adjusting a hydrogen partial pressure at 0.05 MPa.

After reacting for one hour, methanol (3 mL) was introduced, followed by depressurization.

The resulting polymerization reaction solution was introduced into acetone (200 mL) to precipitate a deposit.

This deposit was heat dried to obtain 96 g of a desired polymer.

Its catalytic activity was 1,050 kg/g-Zr·h.

### Example 2

### Preparation of Catalyst 2

In a 500 mL Schlenk bottle, dehydrated toluene (35.6 mL) was added at 25° C. in a stream of nitrogen.

Furthermore, a heptane solution of triisobutylaluminum (0.4 mL, 2 M) and a toluene solution of (1,2′-dimethylsilylene)-(2,1′-dimethylsilylene)bis(3-trimethylsilylmethyl-indenyl)-zirconium dichloride (2.0 mL, 10 μmoles/mL) were added in this order with stirring, and propylene was then dissolved in this solution within one minute under a pressure of 0.01 MPa.

Next, a heptane slurry of dimethylanilinium tetrakis-(pentafluorophenyl)borate (2.0 mL, 20 μmoles/mL) was added at 25° C. in a stream of nitrogen, and propylene was fed for 10 minutes with stirring while adjusting at a pressure of 0.01 MPa.

After stopping the feed of propylene, the stirring was carried out for an additional 20 minutes.

Judging from a change in weight before feeding propylene and after the polymerization, a polymerization amount of propylene was found to be 1.0 g.

1 mL of the resulting catalyst homogeneous solution was introduced into acetone, and the resulting deposit was dried under reduced pressure.

The resulting propylene polymer had an intrinsic viscosity [η] of 0.22 dL/g.

### (Polymerization)

In a 1 L autoclave, heptane (400 mL) was added at 25° C. in a stream of nitrogen, and a heptane solution of triiso-butylaluminum (2 M, 0.3 mmoles, 0.15 mL) was introduced.

Next, hydrogen was introduced at 0.25 MPa, and propylene was introduced such that a total pressure was 0.8 MPa.

Furthermore, the temperature was increased to 70° C. with stirring; the foregoing catalyst solution (0.8 mL) was introduced; and the mixture was allowed to react for 30 minutes.

After completion of the reaction, depressurization was carried out, and the reaction solution was introduced into methanol (2 L) to obtain 232 g of a propylene polymer.

This had an intrinsic viscosity [η] of 0.36 L/g and a catalytic activity of 6,360 kg/g-Zr·h.

### Example 3

In a 1 L autoclave, heptane (400 mL) was added at 25° C. in a stream of nitrogen, and a heptane solution of triiso-butylaluminum (2 M, 0.3 mmoles, 0.15 mL) was introduced.

Next, hydrogen was introduced at 0.25 MPa, and propylene was introduced such that a total pressure was 0.8 MPa.

Furthermore, the temperature was increased to 70° C. with stirring; the solution of Catalyst 1 prepared in Example 1 (0.8 mL) was introduced; and the mixture was allowed to react for 30 minutes.

After completion of the reaction, depressurization was carried out, and the reaction solution was introduced into methanol (2 L) to obtain 220 g of a propylene polymer.

This had an intrinsic viscosity [η] of 0.36 L/g and a catalytic activity of 6,030 kg/g-Zr·h.

### Comparative Example 3

In a 1 L autoclave, heptane (400 mL) was added at 25° C. in a stream of nitrogen, and a heptane solution of triiso-butylaluminum (2 M, 0.3 mmoles, 0.15 mL) was introduced.

Next, hydrogen was introduced at 0.25 MPa, and propylene was introduced such that a total pressure was 0.8 MPa.

Furthermore, the temperature was increased to 70° C. with stirring; a toluene solution of (1,2′-dimethylsilylene)-(2,1′-dimethylsilylene)bis(3-trimethylsilylmethyl-indenyl) zirconium dichloride (0.08 mL, 10 μmoles/mL) and a heptane slurry of dimethylanilinium tetrakis(pentafluorophenyl)borate (0.20 mL, 20 μmoles/mL) were introduced; and the mixture was allowed to react for 30 minutes.

After completion of the reaction, depressurization was carried out, and the reaction solution was introduced into methanol (2 L) to obtain 154 g of a propylene polymer.

This had an intrinsic viscosity [η] of 0.35 L/g and a catalytic activity of 4,230 kg/g-Zr·h.

### Example 4

### Preparation of Catalyst 3

In a 50 mL Schlenk bottle, dehydrated toluene (7 mL) was added at 25° C. in a stream of nitrogen.

Next, a toluene solution of methylalumoxane (0.05 mL, 3.2 mmoles/mL) as manufactured by Albemarle Corporation, LINEALENE 18 (major component: 1-octadecene) (1.0 mL) as manufactured by Idemitsu Kosan Co., Ltd., a toluene solution of (1,2′-dimethylsilylene) (2,1′-dimethylsilylene)bis(3-trimethylsilylmethyl-indenyl)zirconium dichloride (1.0 mL, 10 μmoles/mL) and a heptane slurry of dimethylanilinium tetrakis-(pentafluorophenyl)borate (1.0 mL, 20 μmoles/mL) were added in this order with stirring, and the stirring was continued for 24 hours.

1 mL of the resulting catalyst homogenous solution was introduced into 10 mL of acetone; and a deposit was dried under reduced pressure to obtain 0.1 g of a polymer. This had an intrinsic viscosity [η] of 0.18 dL/g.

### (Polymerization)

In a 1 L autoclave, heptane (400 mL) was added at 25° C. in a stream of nitrogen, and a toluene solution of methylalumoxane (0.15 mL, 3.2 mmoles/mL) as manufactured by Albemarle Corporation was introduced.

Next, hydrogen was introduced at 0.25 MPa, and propylene was introduced such that a total pressure was 0.8 MPa.

Furthermore, the temperature was increased to 70° C. with stirring; the foregoing solution of Catalyst 3 (0.8 mL) was introduced; and the mixture was allowed to react for 30 minutes.

After completion of the reaction, depressurization was carried out, and the reaction solution was introduced into methanol (2 L) to obtain 200 g of a propylene polymer.

This had an intrinsic viscosity [η] of 0.38 L/g and a catalytic activity of 5,480 kg/g-Zr·h.

### Example 5

### Preparation of Catalyst 4

In a 500 mL Schlenk bottle, dehydrated toluene (35.6 mL) was added at 25° C. in a stream of nitrogen.

Next, a heptane solution of tetraisobutylaluminoxane (0.4 mL, 2 M) and a toluene solution of (1,2′-dimethylsilylene)-(2,1′-dimethylsilylene)bis(3-trimethylsilylmethyl-indenyl) zirconium dichloride (2.0 mL, 10 μmoles/mL) were added in this order with stirring, and propylene was then dissolved in this solution within one minute under a pressure of 0.01 MPa.

Furthermore, a heptane slurry of dimethylanilinium tetrakis(pentafluorophenyl)borate (2.0 mL, 20 μmoles/mL) was added at 25° C. in a stream of nitrogen, and propylene was fed for 10 minutes with stirring while adjusting at a pressure of 0.01 MPa.

After stopping the feed of propylene, the stirring was carried out for an additional 20 minutes.

Judging from a change in weight before feeding propylene and after the polymerization, a polymerization amount of propylene was found to be 1.1 g.

10 mL of the resulting catalyst homogeneous solution was introduced into methanol, and the resulting deposit was dried under reduced pressure.

The resulting propylene polymer had an intrinsic viscosity [η] of 0.25 dL/g.

### (Polymerization)

In a 1 L autoclave, heptane (400 mL) was added at 25° C. in a stream of nitrogen, and a heptane solution of tetraisobutylaluminoxane (0.4 mL, 2 M) was introduced.

Next, hydrogen was introduced at 0.25 MPa, and propylene was introduced such that a total pressure was 0.8 MPa.

Furthermore, the temperature was increased to 70° C. with stirring; the foregoing solution of Catalyst 4 (0.8 mL) was introduced; and the mixture was allowed to react for 30 minutes.

After completion of the reaction, depressurization was carried out, and the reaction solution was introduced into methanol (2 L) to obtain 215 g of a propylene polymer.

This had an intrinsic viscosity [η] of 0.38 L/g and a catalytic activity of 5,890 kg/g-Zr·h.

### Example 6

### Preparation of Catalyst 5

In a 5 L Schlenk bottle equipped with a stirrer, dehydrated toluene (3 L), 1.0 L of LINEALENE 18 (major component: 1-octadecene, which had been subjected to a bubbling treatment with nitrogen for 12 hours in advance) as manufactured by Idemitsu Kosan Co., Ltd., 20.0 mL (0.89 mmoles/L) of a toluene solution of triisobutylaluminum, 500 mL of a toluene slurry of (1,2′-dimethylsilylene)(2,1′-dimethylsilylene)bis (3-trimethylsilylmethyl-indenyl)zirconium dichloride (20 mmoles/L) of Referential Example 1 and 500 mL of a toluene slurry of dimethylanilinium tetrakis(pentafluorophenyl)borate (20 mmoles/mL) were added in this order at 25° C. in a stream of nitrogen, and the mixture was stirred for 6 hours to obtain a homogeneous catalyst.

A concentration of the resulting catalyst was 2 mmoles/L.

### (Polymerization)

In a stainless steel-made reactor equipped with a stirrer and having an inner volume of 0.25 m³, 20 L/h of dehydrated n-heptane, 16 mmoles/h of triisobutylaluminum (manufactured by Nippon Aluminum Alkyls, Ltd.) and 15 μmoles/h of the foregoing solution of Catalyst 5 were continuously fed.

Propylene and hydrogen were continuously fed and allowed to react for 48 hours so as to keep a polymerization temperature at 70° C., a hydrogen concentration in a vapor phase at 35% by mole and a total pressure within the reactor at 0.75 MPa·G, respectively.

Incidentally, the solution of Catalyst 5 was continuously fed stably into the reactor during the polymerization for 48 hours.

After adding 500 ppm of IRGANOX 1010 (manufactured by Ciba Specialty Chemicals) in the resulting polymerization solution, the solvent was removed at a jacket temperature of 200° C.

A yield of the propylene polymer was 2.5 kg/hr.

Also, this had an intrinsic viscosity [η] of 0.45 L/g and a catalytic activity of 1,830 kg/g-Zr·h.

### Example 7

### Preparation of Catalyst 6

In a 50 mL Schlenk bottle, dehydrated heptane (1 mL) was added at 25° C. in a stream of nitrogen.

Next, a heptane solution of triisobutylaluminum (0.1 mL, 2 M), LINEALENE 18 (major component: 1-octadecene) (1.0 mL) as manufactured by Idemitsu Kosan Co., Ltd., a heptane slurry of (1,2′-dimethylsilylene)(2,1′-dimethylsilylene)bis-(3-trimethylsilylmethyl-indenyl)zirconium dichloride (1.0 mL, 20 μmoles/mL) of Referential Example 1 and a heptane slurry of dimethylanilinium tetrakis(pentafluorophenyl)borate (1.0 mL, 20 μmoles/mL) were added in this order with stirring, and the stirring was continued for 48 hours.

Thereafter, 30 mL of a heptane solution of triisobutylaluminum (0.02 mmoles/mL) as prepared in advance was introduced.

4 mL of the resulting catalyst homogeneous solution was introduced into 10 mL of acetone, and a deposit was dried under reduced pressure to obtain 0.4 g of a polymer.

This had an intrinsic viscosity [η] of 0.31 dL/g.

### (Polymerization)

In a 1 L autoclave, LINEALENE 18 (major component: 1-octadecene) (400 mL) as manufactured by Idemitsu Kosan Co., Ltd. was introduced in a stream of nitrogen, and a heptane solution of triisobutylaluminum (2 M, 0.5 mmoles, 0.25 mL) was introduced at 25° C.

Next, the temperature was increased to 70° C. over 5 minutes; and after introducing the foregoing catalyst solution (1.0 mL), the mixture was allowed to react continuously while adjusting a hydrogen partial pressure at 0.05 MPa.

After reacting for one hour, methanol (3 mL) was introduced, followed by depressurization.

The resulting polymerization reaction solution was introduced into acetone (200 mL) to precipitate a deposit.

This deposit was heat dried to obtain 20 g of a desired polymer.

This had an intrinsic viscosity [η] of 0.32 L/g and a catalytic activity of 110 kg/g-Zr·h.

### Example 8

In a 1 L autoclave, heptane (400 mL) was added at 25° C. in a stream of nitrogen, and a heptane solution of triisobutylaluminum (2 M, 0.3 mmoles, 0.15 mL) was introduced.

Next, the temperature was increased to 70° C. with stirring; after introducing the solution of Catalyst 6 prepared in Example 7 (1.6 mL, 0.5 μmoles/mL), hydrogen was introduced at 0.25 MPa, and propylene was introduced such that a total pressure was 0.8 MPa; and the mixture was allowed to react for one hour.

After completion of the reaction, depressurization was carried out, and the reaction solution was introduced into methanol (2 L) to obtain 189 g of a propylene polymer.

This had an intrinsic viscosity [η] of 0.35 L/g and a catalytic activity of 2,590 kg/g-Zr·h.

### Comparative Example 4

In a 1 L autoclave, LINEALENE 18 (major component: 1-octadecene) (400 mL) as manufactured by Idemitsu Kosan Co., Ltd. was introduced in a stream of nitrogen, and a heptane solution of triisobutylaluminum (2 M, 0.5 mmoles, 0.25 mL) was introduced at 25° C.

Next, the temperature was increased to 70° C. over 5 minutes, and a heptane slurry of (1,2′-dimethylsilylene)-(2,1′-dimethylsilylene)bis(3-trimethylsilylmethyl-indenyl)-zirconium dichloride (0.2 mL, 10 μmoles/mL) of Referential Example 1 and a heptane slurry of dimethylanilinium tetrakis-(pentafluorophenyl)borate (1.0 mL, 20 μmoles/mL) were introduced in this order, and the mixture was allowed to react continuously while adjusting a hydrogen partial pressure at 0.05 MPa.

After reacting for one hour, methanol (3 mL) was introduced, followed by depressurization.

The resulting polymerization reaction solution was introduced into acetone (200 mL) to precipitate a deposit.

This deposit was heat dried to obtain 5 g of a desired polymer.

This had an intrinsic viscosity [η] of 0.30 L/g.

Its catalytic activity was 27 kg/g-Zr·h, a value of which was lower than that of Example 7 in which the catalyst was prepared by using only the heptane solvent.

### Comparative Example 5

In a 1 L autoclave, heptane (400 mL) was added at 25° C. in a stream of nitrogen, and a heptane solution of triisobutylaluminum (2 M, 0.3 mmoles, 0.15 mL) was introduced.

Next, the temperature was increased to 70° C. with stirring; a heptane slurry of (1,2′-dimethylsilylene)(2,1′-dimethyl-silylene)bis(3-trimethylsilylmethyl-indenyl)zirconium dichloride (0.08 mL, 10 μmoles/mL) of Referential Example 1 and a heptane slurry of dimethylanilinium tetrakis-(pentafluorophenyl)borate (0.04 mL, 20 μmoles/mL) were introduced in this order; and hydrogen was introduced at 0.25 MPa, and propylene was introduced such that a total pressure was 0.8 MPa.

After reacting for one hour, depressurization was carried out, and the polymerization reaction solution was introduced into methanol (2 L) to precipitate a deposit.

This deposit was heat dried to obtain 64 g of a desired polymer.

This had an intrinsic viscosity [η] of 0.32 L/g.

Its catalytic activity was 880 kg/g-Zr·ht, a value of which was lower than that of Example 8 in which Catalyst 6 was prepared by using only the heptane solvent.

### Example 9

### Preparation of Catalyst 7

In a 50 mL Schlenk bottle, dehydrated heptane (1 mL) was added at 25° C. in a stream of nitrogen.

Next, a heptane solution of triisobutylaluminum (0.1 mL, 2 M), LINEALENE 18 (major component: 1-octadecene) (1.0 mL) as manufactured by Idemitsu Kosan Co., Ltd., a heptane slurry of (1,2′-dimethylsilylene)(2,1′-dimethylsilylene)bis-(3-trimethylsilylmethyl-indenyl)zirconium dichloride (1.0 mL, 20 μmoles/mL) of Referential Example 1 and a heptane slurry of dimethylanilinium tetrakis(pentafluorophenyl)borate (1.0 mL, 20 μmoles/mL) were added in this order with stirring.

Next, a balloon filled with hydrogen was installed; after depressurizing the inside of the Schlenk bottle, hydrogen was introduced; and the mixture was stirred for 24 hours.

Thereafter, 30 mL of a heptane solution of triisobutylaluminum (0.02 mmoles/mL) as prepared in advance was introduced.

4 mL of the resulting catalyst homogeneous solution was introduced into 10 mL of acetone, and a deposit was dried under reduced pressure to obtain 0.4 g of a polymer.

This had an intrinsic viscosity [η] of 0.20 dL/g.

### (Polymerization)

In a 1 L autoclave, LINEALENE 18 (major component: 1-octadecene) (400 mL) as manufactured by Idemitsu Kosan Co., Ltd. was introduced in a stream of nitrogen, and a heptane solution of triisobutylaluminum (2 M, 0.5 mmoles, 0.25 mL) was introduced at 25° C.

Next, the temperature was increased to 70° C. over 5 minutes; and after introducing the foregoing catalyst solution (1.0 mL), the mixture was allowed to react continuously while adjusting a hydrogen partial pressure at 0.05 MPa.

After reacting for one hour, methanol (3 mL) was introduced, followed by depressurization.

The resulting polymerization reaction solution was introduced into acetone (200 mL) to precipitate a deposit.

This deposit was heat dried to obtain 25 g of a desired polymer.

This had an intrinsic viscosity [η] of 0.31 L/g and a catalytic activity of 140 kg/g-Zr·h.

### Example 10

### Preparation of Catalyst 8

In a 300 mL Schlenk bottle, dehydrated methylcyclohexane (33.5 mL) was added at 25° C. in a stream of nitrogen.

Next, a heptane solution of triisobutylaluminum (1.25 mL, 2 M), LINEALENE 18 (major component: 1-octadecene) (10.0 mL) as manufactured by Idemitsu Kosan Co., Ltd., a heptane slurry of (1,2′-dimethylsilylene)(2,1′-dimethylsilylene)bis-(3-trimethylsilylmethyl-indenyl)zirconium dichloride (2.5 mL, 20 μmoles/mL) of Referential Example 1 and a heptane slurry of dimethylanilinium tetrakis(pentafluorophenyl)borate (2.75 mL, 20 μmoles/mL) were added in this order with stirring; the temperature was increased to 40° C.; and the mixture was stirred for 8 hours.

1 mL of the resulting catalyst homogeneous solution was introduced into 10 mL of acetone, and a deposit was dried under reduced pressure to obtain 0.14 g of a polymer.

This had an intrinsic viscosity [η] of 0.12 dL/g.

### (Polymerization)

In a 1 L autoclave, LINEALENE 18 (major component: 1-octadecene) (400 mL) as manufactured by Idemitsu Kosan Co., Ltd. was introduced in a stream of nitrogen; the temperature was increased to 75° C.; and a heptane solution of triisobutylaluminum (2 M, 1.0 mmole, 0.5 mL) was introduced.

Next, after introducing the foregoing catalyst solution (1.0 mL), the mixture was allowed to react continuously while adjusting a hydrogen partial pressure at 0.03 MPa.

After reacting for 30 minutes, methanol (3 mL) was introduced, followed by depressurization.

The resulting polymerization reaction solution was introduced into acetone (200 mL) to precipitate a deposit.

This deposit was heat dried to obtain 93 g of a desired polymer.

Its catalytic activity was 2,039 kg/g-Zr·h.

### Example 11

In a 1 L autoclave, heptane (400 mL) was added at 25° C. in a stream of nitrogen, and a heptane solution of triisobutylaluminum (2 M, 0.3 mmoles, 0.15 mL) was introduced.

Next, the temperature was increased to 80° C. with stirring; after introducing the solution of Catalyst 8 prepared in Example 10 (0.6 mL, 1.0 μmole/mL), hydrogen was introduced at 0.04 MPa, and propylene was introduced such that a total pressure was 0.8 MPa; and the mixture was allowed to react for 30 minutes.

After completion of the reaction, depressurization was carried out, and the reaction solution was introduced into methanol (2 L) to obtain 247 g of a propylene polymer.

This had an intrinsic viscosity [η] of 0.45 L/g and a catalytic activity of 9,026 kg/g-Zr·h.

### Example 12

In a 1 L autoclave, LINEALENE 2024 (containing 5% of 1-octadecene, 40% of 1-docosene, 36% of 1-eicosene and 19% of 1-tetracosene) (400 mL) as manufactured by Idemitsu Kosan Co., Ltd. was introduced in a stream of nitrogen; the temperature was increased to 80° C.; and a heptane solution of triisobutylaluminum (2 M, 1.0 mmole, 0.5 mL) was introduced.

Next, after introducing the solution of Catalyst 8 prepared in Example 10 (1.0 mL, 1.0 μmole/mL), the mixture was allowed to react continuously while adjusting a hydrogen partial pressure at 0.03 MPa.

After reacting for 30 minutes, methanol (3 mL) was introduced, followed by depressurization.

The resulting polymerization reaction solution was introduced into methyl ethyl ketone (400 mL) to precipitate a deposit.

This deposit was heat dried to obtain 85 g of a desired polymer.

Its catalytic activity was 1,864 kg/g-Zr·h.

### Example 13

### Preparation of Monomer

LINEALENE 2024 as manufactured by Idemitsu Kosan Co., Ltd. was distilled under reduced pressure (from 0.27 to 1.87 kPa) at a distillation temperature of from 140 to 230° C. to obtain a fraction having a composition ratio of 63.5% of a component having 22 carbon atoms and 36.5% of a component having 24 carbon atoms.

In a heat dried 500 mL Schlenk bottle, 500 mL of the foregoing monomer was introduced and subjected to a dehydration treatment for 8 hours by using dry nitrogen and active alumina.

### (Polymerization)

In a 1 L autoclave, the foregoing monomer (400 mL) was added in a stream of nitrogen; the temperature was increased to 80° C.; and a heptane solution of triisobutylaluminum (2 M, 1.0 mmole, 0.5 mL) was introduced.

Next, after introducing the solution of Catalyst 8 prepared in Example 10 (1.0 mL, 1.0 μmole/mL), the mixture was allowed to react continuously while adjusting a hydrogen partial pressure at 0.03 MPa.

After reacting for 30 minutes, methanol (3 mL) was introduced, followed by depressurization.

The resulting polymerization reaction solution was introduced into methyl ethyl ketone (400 mL) to precipitate a deposit.

This deposit was heat dried to obtain 80 g of a desired polymer.

Its catalytic activity was 2,192 kg/g-Zr·h.

### Example 14

### Preparation of Catalyst 9

In a 300 mL Schlenk bottle, dehydrated methylcyclohexane (33.5 mL) was added at 25° C. in a stream of nitrogen.

Next, a heptane solution of triisobutylaluminum (1.25 mL, 2 M), LINEALENE 18 (major component: 1-octadecene) (10.0 mL) as manufactured by Idemitsu Kosan Co., Ltd., a heptane slurry of (1,2′-dimethylsilylene)(2,1′-dimethylsilylene)(3-trimethylsilylmethylindenyl) (indenyl)zirconium dichloride (2.5 mL, 20 μmoles/mL) of Referential Example 2 and a heptane slurry of dimethylanilinium tetrakis(pentafluorophenyl)borate (2.75 mL, 20 μmoles/mL) were added in this order with stirring; the temperature was increased to 40° C.; and the mixture was stirred for 8 hours.

1 mL of the resulting catalyst homogeneous solution was introduced into 10 mL of acetone, and a deposit was dried under reduced pressure to obtain 0.13 g of a polymer.

This had an intrinsic viscosity [η] of 0.10 dL/g.

### (Polymerization)

In a 1 L autoclave, LINEALENE 2024 (containing 5% of 1-octadecene, 40% of 1-docosene, 36% of 1-eicosene and 19% of 1-tetracosene) (400 mL) as manufactured by Idemitsu Kosan Co., Ltd. was introduced in a stream of nitrogen; the temperature was increased to 80° C.; and a heptane solution of triisobutylaluminum (2 M, 1.0 mmole, 0.5 mL) was introduced.

Next, after introducing the foregoing catalyst solution (1.0 mL), the mixture was allowed to react continuously while adjusting a hydrogen partial pressure at 0.03 MPa.

After reacting for 30 minutes, methanol (3 mL) was introduced, followed by depressurization.

The resulting polymerization reaction solution was introduced into methyl ethyl ketone (400 mL) to precipitate a deposit.

This deposit was heat dried to obtain 103 g of a desired polymer.

Its catalytic activity was 2,259 kg/g-Zr·h.

Regarding each of the poly-α-olefins obtained in the Examples and Comparative Examples, the melting point and catalytic activity are shown in Table 1.

### (Measurement Method of Melting Point)

The melting point was measured by using a differential scanning calorimeter (DSC7, manufactured by Perkin Elmer Inc.) in the following method.

An endothermic peak top of a melting endothermic curve obtained by holding a sample in a nitrogen atmosphere of 190° C. for 5 minutes, dropping the temperature to −10° C. at 5° C./min, holding at −10° C. for 5 minutes and then increasing the temperature to 190° C. at 10° C./min was defined as a melting point.

TABLE 1

| | | Catalytic activity |
|---|---|---|
| | Melting point (° C.) | kg/g-Zr · h |
| Example 1 | 42 | 2,490 |
| Example 7 | 42 | 110 |
| Example 10 | 42 | 2,039 |
| Example 12 | 52 | 1,864 |
| Example 13 | 62 | 2,192 |
| Example 14 | 52 | 2,259 |
| Comparative Example 1 | 42 | 1,600 |
| Comparative Example 2 | 42 | 1,050 |
| Comparative Example 4 | 42 | 27 |

### Referential Example 1

### Production of Double-Crosslinked Complex [(1,2′-dimethylsilylene)(2,1′-dimethylsilylene)-bis(3-trimethylsilylmethylindenyl)zirconium Dichloride]

In a Schlenk bottle, 3.0 g (6.97 mmoles) of a lithium salt of (1,2′-dimethylsilylene) (2,1′-dimethylsilylene)-bis(indene) is dissolved in 50 mL of THF (tetrahydrofuran) and cooled to −78° C.

2.1 mL (14.2 mmoles) of iodomethyltrimethylsilane was slowly added dropwise, and the mixture was stirred at room temperature for 12 hours.

The solvent was distilled off, 50 mL of ether was added, and the mixture was rinsed with a saturated ammonium chloride solution.

After liquid separation, an organic phase was dried, and the solvent was removed to obtain 3.04 g (5.88 mmoles) of (1,2′-dimethylsilylene)(2,1′-dimethylsilylene)-bis(3-trimethylsilylmethylindene) (yield: 84%).

Next, 3.04 g (5.88 mmoles) of (1,2′-dimethylsilylene)-(2,1′-dimethylsilylene)-bis(3-trimethylsilylmethylindene) obtained above and 50 mL of ether are charged in a Schlenk bottle in a stream of nitrogen.

The mixture was cooled to −78° C., and a hexane solution of n-BuLi (1.54 M, 7.6 mL (1.7 mmoles)) was added dropwise.

The temperature was returned to room temperature, and after stirring for 12 hours, the ether was distilled off.

The resulting solid was rinsed with 40 mL of hexane to obtain 3.06 g (5.07 mmoles) of a lithium salt as a ether adduct (yield: 73%).

The result of the measurement of ¹H-NMR (90 MHz, THF-d₈) was as follows.

δ: 0.04 (s, 18H, trimethylsilyl); 0.48 (s, 12H, dimethylsilylene); 1.10 (t, 6H, methyl); 2.59 (s, 4H, methylene); 3.38 (q, 4H, methylene); 6.2 to 7.7 (m, 8H, Ar—H)

Next, the resulting lithium salt was dissolved in 50 mL of toluene in a stream of nitrogen.

The solution was cooled to −78° C., and a toluene suspension (20 mL) of 1.2 g (5.1 mmoles) of zirconium tetrachloride which had been cooled to −78° C. in advance was added dropwise thereto.

After the dropwise addition, the mixture was stirred at room temperature for 6 hours, and the solvent of the reaction solution was distilled off.

The resulting residue was recrystallized by using dichloro-methane to obtain 0.9 g (1.33 mmoles) of (1,2′-dimethylsilylene)-(2,1′-dimethylsilylene)-bis(3-trimethylsilylmethylindenyl)-zirconium dichloride (yield: 26%).

The result of the measurement of ¹H-NMR (90 MHz, CDCl₃) was as follows.

δ: 0.0 (s, 18H, trimethylsilyl); 1.02 and 1.12 (s, 12H, dimethylsilylene); 2.51 (dd, 4H, methylene); 7.1 to 7.6 (m, 8H, Ar—H)

### Referential Example 2

### Production of Double-Crosslinked Complex [(1,2′-dimethylsilylene) (2,1′-dimethylsilylene)-(3-trimethylsilylmethylindenyl)(indenyl)zirconium Dichloride]

In a 200 mL Schlenk bottle, 50 mL of diethyl ether and 3.5 g (10.2 mmoles) of (1,2′-dimethylsilylene)-(2,1′-dimethylsilylene)-bis(indene) were added in a stream of nitrogen, and a hexane solution of n-BuLi (1.60 moles/L, 12.8 mL) was added dropwise thereto at −78° C.

After stirring at room temperature for 8 hours, the solvent was distilled off, and the resulting solid was dried under reduced pressure to obtain 5.0 g of a white solid.

This solid was dissolved in 50 mL of THF (tetrahydrofuran), and 1.4 mL of iodomethyltrimethylsilane was added dropwise thereto at room temperature.

Next, 10 mL of water was added to achieve hydrolysis; an organic phase was extracted with 50 mL of ether; an organic phase was dried, and the solvent was distilled off.

10 mL of ether was added thereto, and a hexane solution of n-BuLi (1.60 moles/L, 12.8 mL) was added dropwise at −78° C.

After stirring at room temperature for 3 hours, the ether was distilled off.

The resulting solid was rinsed with 30 mL of hexane and then dried under reduced pressure.

5.11 g of this white solid was suspended in 50 mL of toluene, and 2.0 g (8.6 mmoles) of zirconium tetrachloride suspended in 10 mL of toluene in another Schlenk bottle was added thereto.

After stirring at room temperature for 12 hours, the solvent was distilled off; and the residue was rinsed with 50 mL of hexane and then recrystallized from 30 mL of dichloromethane to obtain 1.2 g of (1,2′-dimethylsilylene) (2,1′-dimethylsilylene)-(3-trimethylsilylmethylindenyl)(indenyl)zirconium dichloride as a yellow fine crystal (yield: 25%).

The result of the measurement of ¹H-NMR (90 MHz, CDCl₃) was as follows.

δ: 0.09 (s, 9H, trimethylsilyl); 0.89, 0.86, 1.03 and 1.06 (s, 12H, dimethylsilylene); 2.20 and 2.65 (d, 2H, methylene); 6.99 (s, 1H, CH); 7.0 to 7.8 (m, 8H, Ar—H)

### INDUSTRIAL APPLICABILITY

By polymerizing an α-olefin having from 3 to 30 carbon atoms by using the polymerization catalyst of the present invention, a poly-α-olefin can be inexpensively produced in a high yield with ease.

1. A polymerization catalyst produced by a process comprising bringing into contact with each other component (A) comprising a transition metal compound, component (B) comprising a solid boron compound capable of forming an ion pair with the component (A), component (C) comprising an organoaluminum compound, and component (D) comprising one or more kinds of compounds selected from an α-olefin, an internal olefin, and a polyene.

2. The polymerization catalyst according to claim 1, wherein the component (D) is an α-olefin having from 3 to 30 carbon atoms and the component (D)/component (A) are brought into contact in a molar ratio of from 10 to 100,000.

3. The polymerization catalyst according to claim 1, wherein the components (A), (B), (C) and (D) are brought into contact with each other in the presence of component (E) comprising a hydrocarbon based solvent.

4. The polymerization catalyst according to claim 3, wherein the component (E) is an aliphatic hydrocarbon based solvent.

5. The polymerization catalyst according to claim 3, wherein the component (E) is an alicyclic hydrocarbon based solvent.

6. The polymerization catalyst according to claim 1, wherein the polymerization catalyst is a homogenous catalyst.

7. The polymerization catalyst according to claim 1, wherein the component (A) is a crosslinked ligand-containing metallocene complex.

8. The polymerization catalyst according to claim 7, wherein the crosslinked ligand-containing metallocene complex is a double-crosslinked metallocene complex represented by the general formula (I): 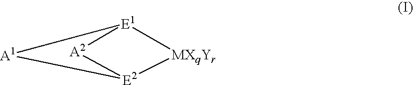
wherein M represents a metal element belonging to the groups 3 to 10 of the periodic table or the lanthanoid series; E¹ and E² each represents a ligand selected from a substituted cyclopentadienyl group, an indenyl group, a substituted indenyl group, a heterocyclopentadienyl group, a substituted heterocyclopentadienyl group, an amide group, a phosphide group, a hydrocarbon group, and a silicon-containing group and forms a crosslinking structure via A¹ and A², and E¹ and E² may be the same or different; X represents a σ-bonding ligand, and when plural Xs are present, the plural Xs may be the same or different or may be crosslinked with other X, E¹, E² or Y; Y represents a Lewis base, and when plural Ys are present, the plural Ys may be the same or different or may be crosslinked with other Y, E¹, E² or X; A¹ and A² each represents a divalent crosslinking group for bonding two ligands and represents a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—; R¹ represents a hydrogen atom, a halogen atom, a hydrocarbon group having from 1 to 20 carbon atoms, or a halogen-containing hydrocarbon group having from 1 to 20 carbon atoms, and A¹ and A² may be the same or different; q represents an integer of from 1 to 5 and represents [(valence of M)−2]; and r represents an integer of from 0 to 3.

9. The polymerization catalyst according to claim 1, wherein the component (C) is selected from one or more of:
a compound represented by the general formula (VIII):
R²⁰ᵥAlJ₃₋ᵥ (VIII)
wherein R²⁰ represents an alkyl group having from 1 to 10 carbon atoms; J represents a hydrogen atom, an alkoxy group having from 1 to 20 carbon atoms, an aryl group having from 6 to 20 carbon atoms, or a halogen atom; and v represents an integer of from 1 to 3;
a chain aluminoxane represented by the general formula (IX): 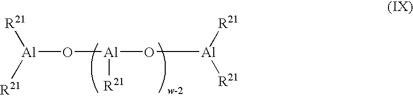
wherein R²¹ represents a hydrocarbon group having from 1 to 20 carbon atoms or a halogen atom; w represents an average degree of polymerization; and respective R²¹ may be the same or different; and
a cyclic aluminoxane represented by the general formula (X): 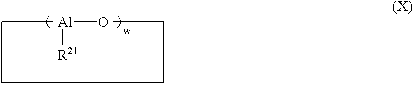
wherein R²¹ and w are the same as those in the foregoing general formula (IX).

10. A method for producing a poly-α-olefin comprising polymerizing an α-olefin having from 3 to 30 carbon atoms in the presence of the polymerization catalyst according to claim 1.

11. The method for producing a poly-α-olefin according to claim 10, wherein said method further comprises continuously feeding the polymerization catalyst into a polymerization reaction apparatus comprising the α-olefin having from 3 to 30 carbon atoms.
